(19) United States
(12) Patent Application Publication
(10) Pub. No.: US 2006/0119961 A1
(43) Pub. Date: Jun. 8, 2006

(54) Driving X and Y mirrors with minimum electrical feeds

(76) Inventors: Mark W. Heaton, Irving, TX (US); Arthur Monroe Turner, Allen, TX (US)

Correspondence Address: TEXAS INSTRUMENTS INCORPORATED, P O BOX 655474, M/S 3999, DALLAS, TX, 75265, US

(21) Appl. No.: 11/004,766

(22) Filed: Dec. 3, 2004

(51) Int. Cl. G02B 7/182

(52) U.S. Cl. 359/872; 359/298

(57) ABSTRACT

Apparatus and method for providing both a high-speed drive signal for generating and monitoring the scanning sweep of a laser beam and a low speed signal for moving the scanning beam sweep orthogonally and monitoring the orthogonal movement. The apparatus and method uses a single pair of conductors for carrying both the high speed and low speed signals thereby reducing the number of conductors and connectors.

### TECHNICAL FIELD

The present invention relates to the use of torsional hinged mirrors as used to provide a scanning laser beam and also moves in a direction orthogonal to the scanning or sweep motion of the laser beam as used in display or printing apparatus. More particularly, the invention relates to providing the scanning drive signal and the orthogonal motion drive signal with reduced wiring and electrical connectors.

### BACKGROUND

Prior art scanning devices are used to provide a unidirectional sweeping laser beam with typically multifaceted rotating mirrors. However, less expensive high-speed bidirectional torsional hinged mirrors are gaining greater and greater acceptance. Typically printing and/or display apparatus provide a high-speed back and forth sweeping modulated light beam in one plane by pivotal oscillation of a mirror about a primary or selected axis. Slower orthogonal motion of the light beam is provided by a mirror pivoting about another axis that is orthogonal to the primary axis to provide the space raster scan for a display apparatus or to maintain adjacent lines of a printer parallel to each other. The combination high-speed scanning motion and the slower orthogonal motion may be provided by a single dual axis torsional hinge mirror or two single axis mirrors.

However, regardless of whether a single dual axis mirror or two single axis mirrors are used, the high-speed sweep drive signals are provided to a first pair of electrical conductors and the slower orthogonal drive signals are provided to a second pair of electrical conductors and connectors.

Therefore, it would be advantageous if the number of conductors and connectors to the apparatus could be reduced.

### SUMMARY OF THE INVENTION

These and other problems are generally solved or circumvented, and technical advantages are generally achieved, by preferred embodiments of the present invention that provide for a drive system for a scanning mirror arrangement. The apparatus and methods comprise a first or high-speed drive having input terminals and that pivotally oscillates a mirror at a first frequency about a first axis. There is also included a low-speed drive mechanism also having input terminals and the low-speed drive mechanism pivotally oscillates a mirror about a second frequency and about a second axis. The first frequency provided by the first high-speed drive is greater than the second frequency and the input terminals of both the high-speed drive and the low-speed drive are electrically connected in parallel. There is also included an input power source connected to the high-speed and low-speed input terminals of the two drive mechanisms provided by a single pair of conductors. Thus, both the high-speed and low-speed signals are provided on the same conductors.

According to one embodiment of the invention, the high-speed signals are provided at a rate of between about 20 Hz and 30 kHz and preferably at a rate of about 20 kHz. The slow speed signals are provided at a rate of between about 50 Hz and 70 Hz and preferably at a rate of about 70 Hz. Thus, it is seen that there is significant difference in the frequency of the two applied signals.

The drive signals may be provided to a single dual axis mirror having a drive mechanism for each axis, or alternately there may be included two single axis mirrors, each having its own drive input provided by the single connector from the input power source.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1 and 2 are illustrations of two embodiments of single axis mirrors suitable for use with the present invention;

FIG. 3 shows an operational arrangement of two single axis mirrors for reflecting a light beam onto a photosensitive medium;

FIGS. 4 and 5 provide illustrations of two embodiments of a dual axis mirror suitable for use with the present invention;

FIG. 6 shows the operation of one dual axis mirror for reflecting a light beam onto a photosensitive medium;

FIG. 7 illustrates the four wire prior art input drive signal arrangement, and the four wire prior art sensor arrangement; and

FIG. 8 illustrates the two conductor single arrangement of the drive signals, and the two wire sensor arrangement of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

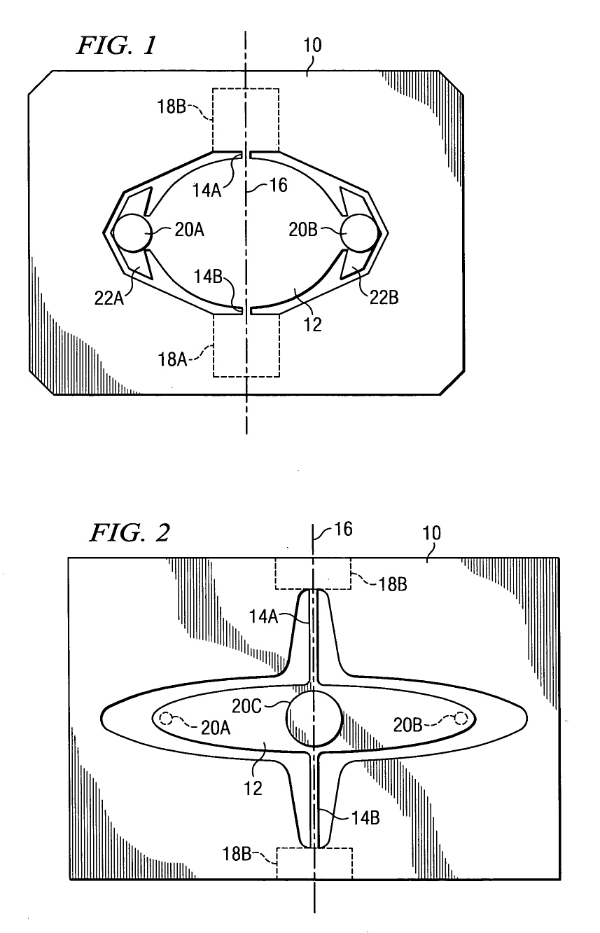

FIGS. 1 and 2 illustrate single axis torsional mirror devices. Each of the devices of FIGS. 1 and 2 include a support member 10 supporting the mirror or reflective surface 12, which may be substantially any shape but for many printer and display applications the elongated ellipse shape of FIG. 2 is preferred. The pivoting mirror is supported by a single pair of torsional hinges 14a and 14b. Thus, it will be appreciated that if the mirror 12 can be maintained in an oscillation state around axis 16 by a drive source, such a mirror could be used to cause a sweeping light beam to repeatedly move across a photosensitive medium.

It will also be appreciated that an alternate embodiment of a single axis device may not require the support member or frame 10 as shown in FIGS. 1 and 2. For example, as shown in both figures, the torsional hinges 14a and 14b may simply extend to a pair of hinge anchor pads 18a and 18b as shown in dotted lines. The functional surface, such as mirror 12, may be suitably polished on its upper surface to provide a specular or mirror surface.

The single layered silicon mirrors are typically MEMS (micro-electric mechanical systems) type mirrors manufactured from a slice of single crystal silicon. Further, because of the advantageous material properties of single crystalline silicon, MEMS based mirrors have a very sharp torsional resonance. The Q of the torsional resonance typically is in the range of 100 to over 2000. This sharp resonance results in a large mechanical amplification of the device's motion at a resonance frequency versus a non-resonant frequency. Therefore, it is typically advantageous to pivot a device about the scanning axis at the resonant frequency. This dramatically reduces the power needed to maintain the mirror in oscillation.

There are many possible drive mechanisms available to provide the oscillation or pivoting motion if the mirror is intended to provide an oscillating beam sweep along the scan axis. For example, FIG. 1 illustrates a magnetic driven mirror having a pair of permanent magnets 20a and 20b mounted on tabs 22a and 22b respectively. The permanent magnets 20a and 20b interact with a pair of coils (to be discussed later) located below the pivoting structure. The mechanical motion of the mirror in the scan axis, or about the hinges 14a and 14b, is typically required to be greater than 15 degrees and may be as great as 30 degrees. Rather than being driven by a pair of magnets 20a and 20b shown in dotted lines, FIG. 2 illustrates the use of a single magnet 20c centrally located on the mirror 12. The drive mechanism for a centrally located single magnet 20c is discussed below. Resonant drive methods typically involve applying a small rotational motion at or near the resonant frequency of the mirror directly to the torsionally hinged functional surface. Alternately, an inertial drive may provide motion at the resonant frequency to the whole structure, which then excites the mirror to resonantly pivot or oscillate about its torsional axis. In inertial resonant type of drive methods a very small motion of the whole silicon structure can excite a very large rotational motion of the device. Suitable inertial resonant drive sources include piezoelectric drives and electrostatic drive circuits.

Further, by carefully controlling the dimension of hinges 14a and 14b (i.e., width, length and thickness) the high speed mirror may be manufactured to have a natural resonant frequency which is substantially the same as the desired operating pivoting speed or oscillating frequency of the mirror. Thus, by providing a mirror with a high-speed resonant frequency substantially equal to the desired pivoting speed or oscillating frequency, the power loading may be reduced. Similarly, by carefully controlling the dimension of hinges 14a and 14b (i.e., width, length and thickness) the slow speed mirror may be manufactured to have a stiffness that enables low drive power while preserving durability. Driving the slow speed mirror below resonance also enables scan shapes other than sinusoidal which can greatly improve scan efficiency.

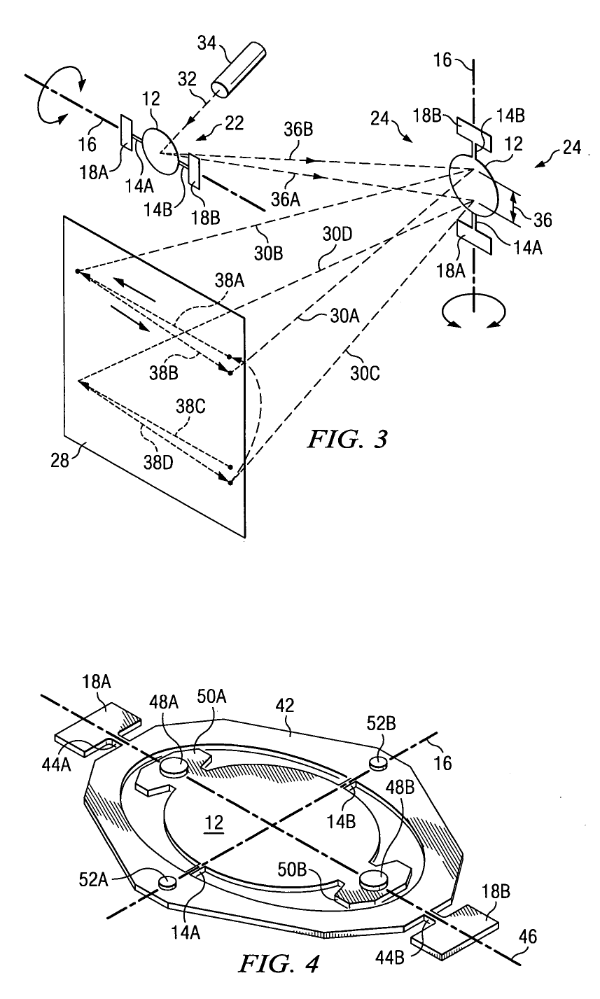

Referring to FIG. 3, there is a perspective illustration of one embodiment of the present invention wherein the resonant scanning is accomplished by a first single axis mirror 24, and the orthogonal movement of the beam is accomplished by a second mirror 26. Each of the two mirrors 24 and 26 pivot about a single axis 16 and operate the same as the single axis mirrors shown in FIGS. 1 and 2. Other than the oscillation speed, the scanning and orthogonal movement of the two single axis mirrors is substantially the same.

Therefore, according to the embodiment of the invention shown in FIG. 3 there is illustrated a first single axis torsional hinged mirror used in combination with a second similar single axis torsional mirror to provide a resonant sweeping beam and orthogonal movement such as may be used with a projection display (or laser printer). As shown in this embodiment, there is a first mirror apparatus 24 that includes a pair of support members or anchors 18a and 18b supporting a mirror or reflective surface 12 by a single pair of torsional hinges 14a and 14b. Thus, it will be appreciated that if the mirror portion 12 can be pivoted back and forth by a drive source about axis 16, the mirror can be used to cause an oscillating light beam across photosensitive display medium or screen 28. A particular advantageous method of pivoting the mirror back and forth is to generate resonant oscillation of the mirror 12 about the torsional hinges 14a and 14b. However, there also needs to be a drive for moving the light beam in a direction orthogonal to the oscillation. Therefore, a second single axis mirror apparatus 26, also of a type similar to those shown in FIGS. 1 and 2, is used to provide the vertical or orthogonal movement of a light beam as it pivots about its axis 16.

As discussed above, the optical system of the embodiment of FIG. 3 uses single axis mirror apparatus 24 to provide the right to left and left to right pivoting of the light beams as represented by dotted lines 30a, 30b, 30c and 30d. However, the up and down control of the beam trajectory is achieved by locating the second single axis mirror apparatus 26 such that the reflective surface 12 of the mirror 26 intercepts the light beam 32 emitted from light source 34 and then reflects the intercepted light, such as beams 36a and 36b, to the mirror apparatus 24 which is providing the back and forth pivoting sweep motion. The double-headed arrow 36 shown on the reflective surface 12 of resonant mirror 24 illustrates how rotation of the mirror 26 around its axis 16 moves the reflected light beam up and down on the reflective surface 12 of mirror 24 as represented by light beams 36a and 36b. Therefore, the left to right and right to left sweep of the light beam reflected from surface 12 of mirror device 24 generates spaced data lines 38a, 38b, 38c and 38d on a projection display medium or screen 28.

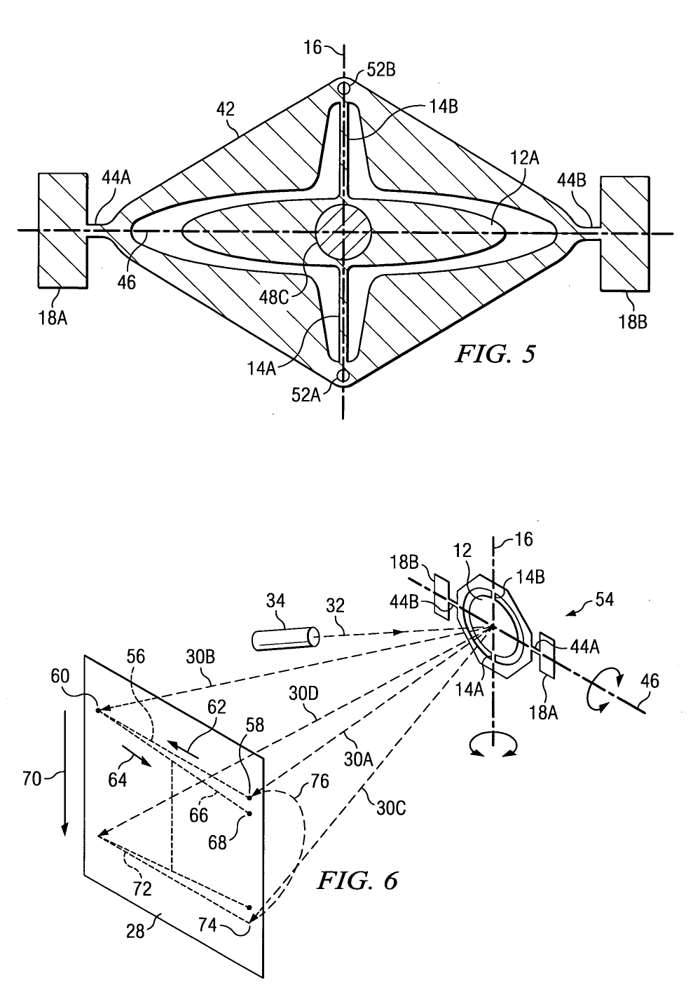

Referring now to FIGS. 4 and 5, there are illustrated two embodiments of dual axis mirrors. As can readily be seen, these mirrors are similar to the single axis mirrors of FIGS. 1 and 2, respectively, discussed above. However, instead of the primary or resonant hinges 14a and 14b, which lie along resonant axis 16, being attached directly to anchor pads 18a and 18b, the primary hinges 14a and 14b are connected to a gimbals member 42, which in turn is connected to the anchor pads 18a and 18b by a second pair of hinges 44a and 44b. Hinges 44a and 44b provide pivotal motion to the mirror 12 along secondary axis 46, which is substantially orthogonal to axis 16.

As shown, FIG. 4 is a perspective view of a single two-axis bi-directional mirror providing resonant movement about the first axis 16 and movement about a second axis 46 that is substantially orthogonal to the first axis. The mirror device can be used to provide back and forth pivoting beam sweeps such as resonant scanning across a projection display screen or moving photosensitive medium as well as adjusting the beam sweep in a direction orthogonal to the back and forth pivoting of the reflective surface or mirror portion 12 to maintain spaced parallel image lines produced by a resonant raster beam sweep. As shown, the mirror is illustrated as being suitable for being mounted on a support structure, and may be formed from a single piece of substantially planar material (such as silicon) by techniques similar to those used in semiconductor art. As discussed above, the functional or moving components include, for example, a pair of support members or anchors 18a and 18b, the intermediate gimbals portion 42 and the inner mirror or reflective surface portion 12. Also as shown, the mirror portion 12 may include a first pair of magnets 48a and 48b mounted on tabs 50a and 50b for providing motion about axis 16 in response to magnetic forces provided by a pair of coils (not shown). A second pair of magnets 52a and 52b mounted on gimbals member 42 provides motion about the orthogonal axis 46 in response to another pair of coils (not shown). The electromagnetic forces are created by the coils and alternates polarity between “N” and “S” in response to an alternating signal, preferably having a frequency the same as the resonant frequency.

FIG. 5 is an alternate embodiment of a dual axis mirror having an elongated oval mirror or reflecting portion 12a and a centrally located drive magnet 48c rather than the two spaced magnets 48a and 48b. Since the remaining elements of the device shown in FIG. 5 operate or function in the same manner as equivalent elements of FIG. 4, the two figures use common reference numbers.

The operation of a dual axis mirror, such as shown in FIGS. 4 and 5 for providing pivoting beam sweep with respect to a projection display screen 40, may be better understood by referring to FIG. 6. As shown, a laser light source 34 provides a coherent beam of light 32 to the reflective surface 12 of a dual axis mirror apparatus 54, which in turn reflects the beam of light as indicated by dashed lines 30a, 30b, 30c and 30d onto a display screen 28. Reflective surface 12 oscillates back and forth at a resonant frequency about torsional hinges 14a and 14b along axis 16 and thereby sweeps the beam 30 across display screen 28 along image line 56 from location or point 58 formed by light beam 30a to end point 60 formed by light beam 30b and as indicated by arrow 62 shown parallel to the sweep of the light beam between beams 30a and 30b. The oscillating mirror 12 then changes direction and starts the return sweep as indicated by arrow 64 to produce image line 66 between points 60 and 68. After passing point 68, the beam again begins reversing direction. At the same time the beam is sweeping back and forth, the beam may also be moved orthogonally at a much slower rate as indicated at arrow 70. This sweeping motion and orthogonal motion is repeated until the last image line 72 of a display frame ending at point 74 is produced on display screen 40. The beam is then orthogonally quickly moved from end point 74 back to start point 58 as indicated by dashed line 76 to start a new display frame.

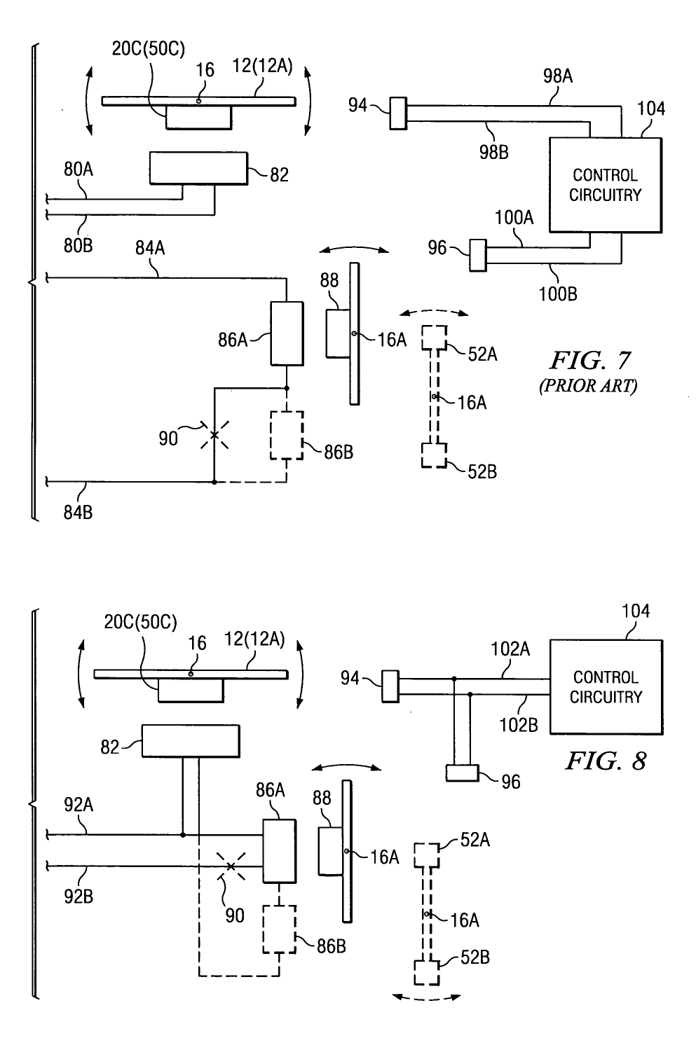

Referring now to FIG. 7, there is shown the four wire prior art wiring and drive arrangement for providing drive power to both a high-speed drive mechanism for receiving an alternating signal to generate the resonant pivotal motion about axis 16, along with a low-speed drive mechanism to generate the slower orthogonal sweep about axis 16a. FIG. 7 also includes the four wire prior art drive arrangement for sensing the high speed and slow speed movement. As shown, a first pair of conductors 80a and 80b are provided to the high-speed, centrally located magnetic drive mechanism, such as the electromagnet 82 and the single permanent magnet 20c bonded to the single axis pivoting mirror 12 shown in FIG. 2, or the permanent magnet 50c bonded to the dual axis pivoting mirror 12a shown in FIG. 5. As mentioned, the slow speed or orthogonal drive mechanism is also provided by its own pair of conductors 84a and 84b as illustrated in the drawing. Conductors 84a and 84b will provide the drive signal to the single electromagnet 86a shown in solid lines, which operate with a centrally located single permanent magnet 88 to provide the slower speed orthogonal motion about axis 16a. Alternately, conductors could provide the orthogonal drive signal to electromagnet 86a and a second electromagnet 86b connected in series with reverse windings as shown in dotted lines. Electromagnets 86a and 86b cooperate with a pair of permanent magnets 52a and 52b such as shown in FIG. 5 to provide the orthogonal motion about axis 16a. If two coils are used, then the solid line connection from coil 86a to the conductor 84b is not made as indicated by the dotted X 90 as shown in FIG. 7.

The primary hinges 14a and 14b as shown in FIGS. 1, 2, 4 and 5 will be designed to have a resonant frequency of between about 20 kHz and 30 kHz. The high-speed drive mechanism will therefore receive signals between about 20 kHz and 30 kHz and, according to one embodiment of the invention, at approximately 20 kHz. On the other hand, the secondary hinges 48a and 48b shown in FIGS. 4 and 5 are designed to have a much slower resonant frequency of about 100 Hz or less and the orthogonal motion drive will therefore be receiving signals at between about 50 Hz and 70 Hz and preferably on the order of about 70 Hz. Thus, as will be appreciated, the high-speed mirror designed to have a resonant frequency around the 20 kHz range will be substantially unaffected by the slower 70 Hz signals whereas hinges designed for the slow motion of the 70 Hz drive will be substantially unaffected by the high-speed signals of the 20 kHz.

Referring now to FIG. 8, it will be appreciated that, according to the present invention, a single pair of wires 92a and 92b can provide both signals to each of the individual drive coils 82 and 86a. Thus, it will be understood that, whereas four wires 80a, 80b, 84a and 84b may have been used to provide the drive signal in the prior art, it is now only necessary to use a single pair of drive conductors 92a and 92b. Except for the reduced number of conductors, since the operation of the circuits is the same, the two figures use common reference numbers. This is also true for an alternate embodiment that uses two serially connected drive coils 86a and 86n and two permanent magnets 52a and 52b as was discussed with respect to FIG. 7.

In a similar manner, it will be appreciated that a pair of sensors, such as for example, a piezoelectric sensors 94 and 96 or any other type of sensor may be used to monitor the speed of both the high-speed mirror and the low speed movement of the mirror along the orthogonal axis. Again, as shown in the prior art view of FIG. 7, typically two wires 98a and 98b were used to provide the feedback signals for the high-speed resonant signals and two wires 100a and 100b were used to provide the feedback for the slower speed orthogonal signals.

However, as is also shown in FIG. 8, because of the difference in the high-speed and the low-speed feedback signals, a single set of conductors or wiring 102a and 102b may be used to provide both feedback signals to the control circuitry 104.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A drive system for a scanning mirror arrangement comprising:
a high-speed drive having input terminals, said high-speed drive for pivotally oscillating a mirror at a first frequency about a first axis;
a low-speed drive having input terminals, said low-speed drive to pivotally oscillate a mirror at a second frequency about a second axis, said first frequency being greater than said second frequency, and said input terminals of said high-speed drive electrically connected in parallel with said input terminals of said low-speed drive;
an input power source connected to said high speed and low speed input terminals, said input power source providing first input signals for generating said pivotal oscillation of said mirror about said first axis and second input terminals signals for generating said pivotal oscillation of said mirror about said second axis.

2. The drive system of claim 1 wherein said mirror oscillating about said first axis is at a rate of between about 20 kHz and about 30 kHz.

3. The drive system of claim 2 wherein said rate is about 20 kHz.

4. The drive system of claim 1 wherein said mirror oscillating about said second axis is at a rate of between about 50 Hz and 70 Hz.

5. The drive system of claim 4 wherein said rate is about 70 Hz.

6. The drive system of claim 2 wherein said mirror oscillating about said second axis is at a rate of between about 50 Hz and 70 Hz.

7. The drive system of claim 1 wherein said mirror oscillation about said first axis is at a rate of about 20 kHz and said mirror oscillation about said second axis is at a rate of about 70 Hz.

8. The drive system of claim 1 wherein said mirror pivotally oscillating at said first frequency about said first axis is the same mirror pivotally oscillating at said second frequency about said second axis.

9. The drive system of claim 8 further comprising a dual axis mirror with a reflecting surface, a gimbal and a support structure, said mirror further comprising a first pair of torsional hinges extending between said reflecting surface and said gimbal for pivoting said reflecting surface about said first axis and a second pair of torsional hinges extending between said support structure and said gimbal for pivoting said gimbal and said reflecting surface about said second axis.

10. The drive system of claim 1 wherein said mirror pivotally oscillating at said first frequency about said first axis is a different mirror than said mirror pivotally oscillating at said second frequency about said second axis.

11. The drive system of claim 10 further comprising a first single axis mirror adapted for receiving a light beam and for reflecting said light beam such that said reflected light beam repeatedly scans along said first axis at said first frequency and a second single axis mirror adapted for receiving said repeatedly scanning reflected light beam and moving the light beam along said second axis at said second frequency.

12. The drive system of claim 1 wherein said mirror arrangement further includes a first permanent magnet arrangement and said high speed drive cooperating with said first permanent magnet arrangement to generate said pivotal oscillation about said first axis and at said first frequency.

13. The drive system of claim 12 wherein said high-speed drive generates said oscillation at the resonant frequency of said scanning mirror.

14. The drive system of claim 1 wherein said high speed drive is a piezoelectric element arrangement for generating said oscillation about said first axis at the resonant frequency of said scanning mirror.

15. The drive system of claim 1 wherein said mirror arrangement further includes a permanent magnet arrangement and said low speed drive cooperates with said permanent magnet to generate said pivotal oscillation about said second axis and at said second frequency.

16. The drive system of claim 12 wherein said mirror arrangement further includes a second permanent magnet arrangement and said low speed drive cooperates with said second permanent magnet arrangement to generate said pivotal oscillation about said second axis and at said second frequency.

17. The drive system of claim 1 further comprising a first sensor for monitoring the pivotal speed of said mirror about said first axis.

18. The drive system of claim 17 wherein said sensor is a piezoelectric element.

19. The drive system of claim 17 further comprising a second sensor for monitoring the pivotal speed of said mirror about the second axis.

20. The drive system of claim 19 wherein said first and second sensors are connected in parallel.

21. The drive system of claim 20 wherein said first and second sensors generate first output signals for providing feedback selected to said mirror about said first axis and second output signals for providing feedback of said mirror about said second axis.

22. A method for driving a scanning mirror arrangement comprising the steps of:
providing a high speed drive having input electrical terminals, said high speed drive adapted for pivotally oscillating a mirror at a first frequency about a first axis;
providing a low speed drive having input electrical terminals, said low speed drive adapted for pivotally oscillating a mirror at a second frequency about a second axis substantially perpendicular to said first axis, said first frequency being greater than said second frequency;
electrically connecting the input terminals of said high speed drive in parallel with the input terminals of said low speed drive; and
applying first input signals and second input signals to said electrical terminals connected in parallel, said first input signal generating said pivotal oscillation about said first axis and said second input signals generating said pivotal oscillation about said second axis.

23. The method of claim 22 wherein said mirror oscillating about said first axis is at a rate of between about 20 kHz and about 30 kHz.

24. The method of claim 23 wherein said rate is about 20 kHz.

25. The method of claim 22 wherein said mirror oscillating about said second axis is at a rate of between about 50 Hz and 70 Hz.

26. The method of claim 25 wherein said rate is about 70 Hz.

27. The method of claim 23 wherein said mirror oscillating about said second axis is at a rate of between about 50 Hz and 70 Hz.

28. The method of claim 22 wherein said mirror oscillation about said first axis is at a rate of about 20 kHz and said mirror oscillation about said second axis is at a rate of about 70 Hz.

29. The method of claim 22 further comprising providing a dual axis mirror as said scanning mirror arrangement.

30. The method of claim 22 further comprising providing a pair of single axis mirrors as said mirror arrangement.

31. The method of claim 22 further comprising the step of monitoring the pivotal speed of said mirror about said first axis.

32. The method of claim 31 and further comprising the step of monitoring the pivotal speed of said mirror about said second axis.

33. The method of claim 32 wherein said monitoring of said pivotal speed about said first and second axis includes connecting said first and second sensors in parallel.
